(19) United States
(12) Patent Application Publication
(10) Pub. No.: US 2011/0128155 A1
(43) Pub. Date: Jun. 2, 2011

(54) EYE PROTECTION APPARATUS AND METHOD

(75) Inventor: MING-CHIH HSIEH, Tu-Cheng (TW)

(73) Assignee: HON HAI PRECISION INDUSTRY CO., LTD., Tu-Cheng (TW)

(21) Appl. No.: 12/730,234

(22) Filed: Mar. 24, 2010

(30) Foreign Application Priority Data
Nov. 27, 2009 (CN) 200910310549.X

(51) Int. Cl. G08B 21/00

(52) U.S. Cl. 340/686.6

(57) ABSTRACT

An eye protection apparatus includes a distance sensor, a mode selecting unit, a power supply, and a processor. The distance sensor detects a distance between a user and a monitor and sends out a distance signal. The mode selecting unit selects one of alarm modes. The processor compares the distance signal with a predetermined value. The protection apparatus alerts the user in the selected alarm mode when the distance signal is less than the predetermined value. An eye protection method is also provided.

### BACKGROUND

1. Technical Field

The present disclosure relates to an eye protection apparatus and a method thereof.

2. Description of Related Art

It can be harmful to a user's eyes when they sit too close to a monitor. However, a typical monitor does nothing to prevent this.

### BRIEF DESCRIPTION OF THE DRAWINGS

FIG. 1 is a schematic view of an embodiment of an eye protection apparatus and a monitor.

FIG. 2 is a block diagram of the eye protection apparatus of FIG. 1.

FIG. 3 is a circuit diagram of an audible alarm member and a processor of the eye protection apparatus of FIG. 2.

FIG. 4 is a flow chart of an embodiment of an eye protection method.

### DETAILED DESCRIPTION

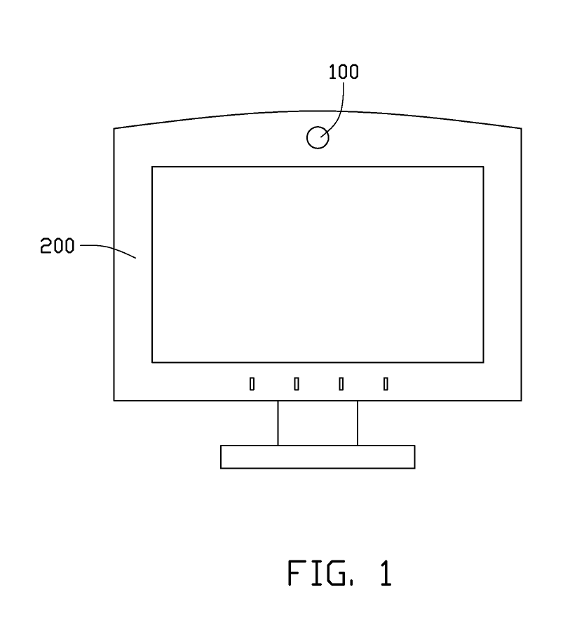

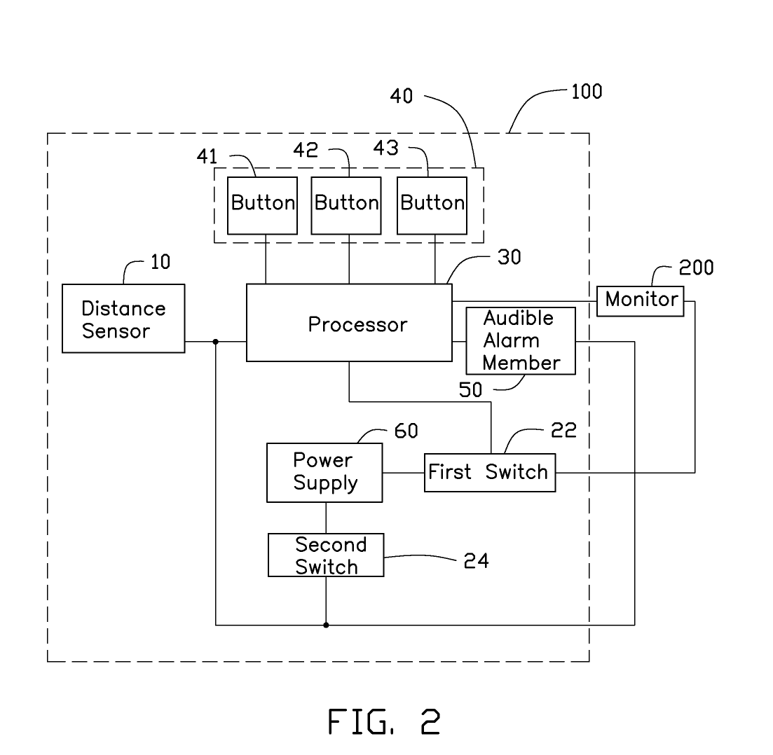

Referring to FIGS. 1 and 2, an embodiment of an eye protection apparatus 100 includes a distance sensor 10, a first switch 22, a second switch 24, a processor 30, a mode selecting unit 40, an audible alarm member 50, and a power supply 60. The mode selecting unit 40 includes three buttons 41, 42, and 43. The eye protection apparatus 100 is set on a monitor 200. The distance sensor 10 is an infrared-ray distance sensor.

The processor 30 is connected to the distance sensor 10, the alarm member 50, the first switch 22, the monitor 200, and the selecting unit 40.

A first terminal of the first switch 22 is connected to the power supply 60. A second terminal of the first switch 22 is connected to the monitor 200. A third terminal of the first switch 22 is connected to the processor 30.

A first terminal of the second switch 24 is connected to the power supply 60. A second terminal of the second switch 24 is connected to the processor 30, the distance sensor 10, and the alarm member 50.

The power supply 60 supplies power to the monitor 200 via the first switch 22. The power supply 60 connects or disconnects to or from the monitor 200 via manual control of the first switch 22.

The power supply 60 supplies power to the processor 30, the distance sensor 10, and the alarm member 50 via the second switch 24. The power supply 60 connects or disconnects to or from the processor 30, the distance sensor 10, and the alarm member 50 via manual control of the second switch 24.

The distance sensor 10 detects a distance between the user and the monitor 200 and sends a distance signal to the processor 30.

The processor 30 stores a predetermined value corresponding to an allowable distance between the user and the monitor 200, and a notice. The processor 30 compares the distance signal with the predetermined value.

The eye protection apparatus 100 has three alarm modes to alarm the user. The alarm modes include: an audible alarm mode, a power control alarm mode, and a visual alarm mode. Alarm modes can be selected by user by pressing one or more of the three buttons 41, 42, 43.

The eye protection apparatus 100 is in the audible alarm mode when the button 41 is pressed. The processor 30 controls the alarm member 50 to alert the user that the distance between the user and the monitor 200 is less than the allowable distance.

The eye protection apparatus 100 is in the power control mode when the button 42 is pressed. The processor 30 controls the first switch 22 to disconnect power from the power supply 60 to the monitor 200 to alert the user that the distance between the user and the monitor 200 is less than the allowable distance.

The eye protection apparatus 100 is in the visual alarm mode when the button 43 is pressed. The processor 30 controls the monitor 200 to display the notice thereon to alert the user that the distance between the user and the monitor 200 is less than the allowable distance.

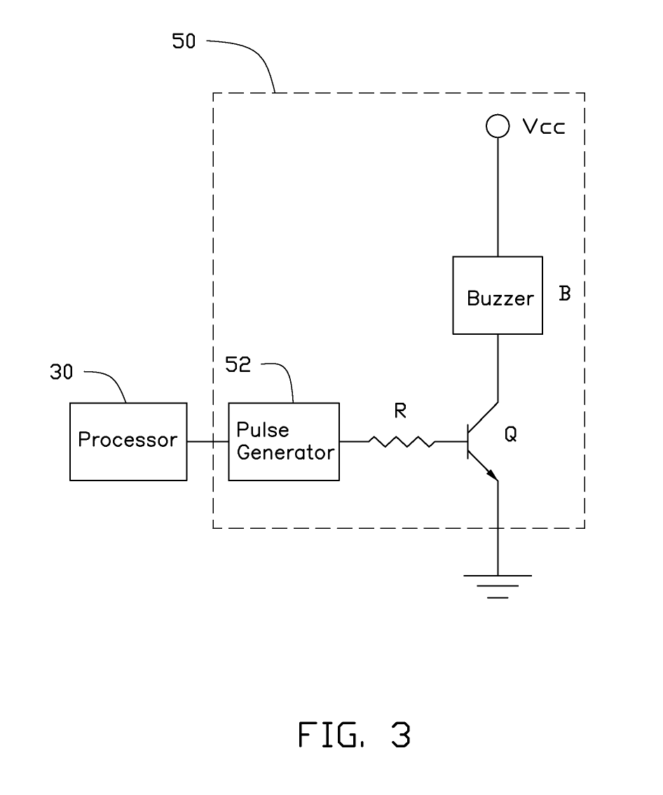

Referring to FIG. 3, the alarm member 50 includes a pulse generator 52, a resistor R, a transistor Q, and a buzzer B. A first terminal of the pulse generator 52 is connected to the processor 30. A second terminal of the pulse generator 52 is connected to a base of the transistor Q via the resistor R. A collector of the transistor Q is connected to a direct current power VCC via the buzzer B. An emitter of the transistor Q is grounded.

The processor 30 controls the pulse generator 52 to generate a rectangular pulse signal when the distance signal is less than the predetermined value. The transistor Q is turned on when the rectangular pulse signal is at a high level and the buzzer B sounds. The transistor Q is turned off when the rectangular pulse signal is at a low level and the buzzer B does not make any sound. Therefore, the buzzer B can quickly turn on and off repeatedly.

The processor 30 controls the pulse generator 52 to stop when the distance signal is not less than the predetermined value. Accordingly, the buzzer B is silent.

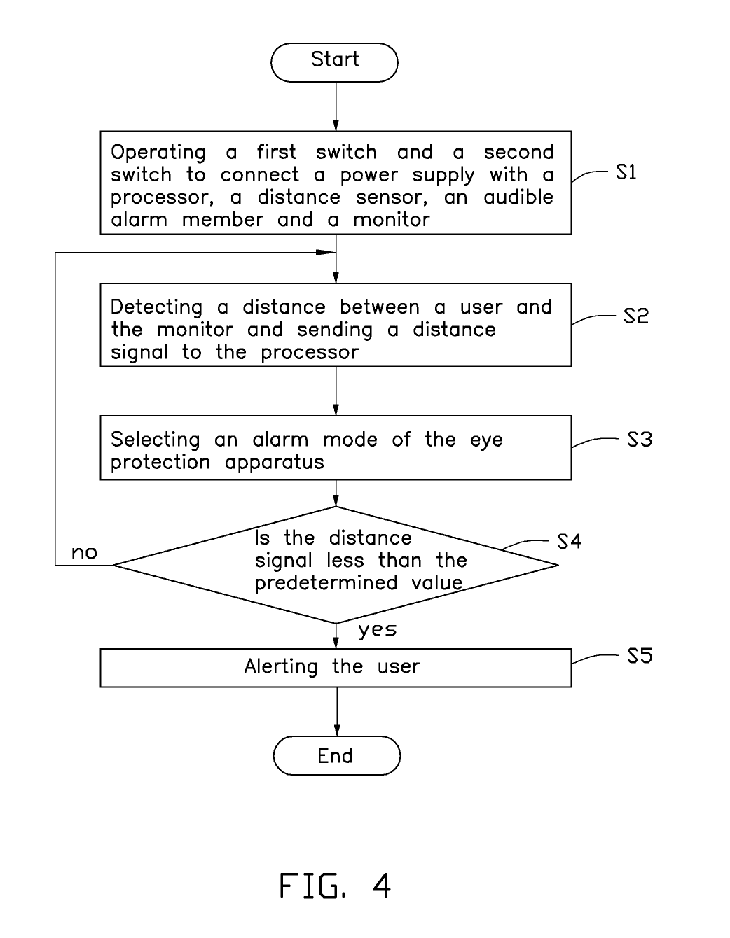

Referring to FIG. 4, an embodiment of an eye protection method includes the following steps:

In step S1, operating a first switch 22 and a second switch 24 to connect a power supply 60 to a processor 30, a distance sensor 10, an audible alarm member 50, and a monitor 200.

In step S2, the distance sensor 10 detects a distance between a user and the monitor 200 and sends a distance signal to the processor 30.

In step S3, an alarm mode of the eye protection apparatus 100 may be selected by a user.

In step S4, the processor 30 compares the distance signal with a predetermined value corresponding to an allowable distance between the user and the monitor 200. If the distance signal is less than the predetermined value, the procedure goes to step S5. If the distance signal is not less than the predetermined value, the procedure goes to step S2.

In step S5, alerting the user when the distance between the user and the monitor 200 is less than the allowable distance if an alarm mode has been selected. When the eye protection apparatus 100 is in the audible alarm mode, the buzzer B sounds. When the eye protection apparatus 100 is in the power control alarm mode, power from the power supply 60 is cut off to the monitor 200. When the eye protection apparatus 100 is in the visual alarm mode, the monitor 200 will display a notice.

The foregoing description of the exemplary embodiments of the disclosure has been presented only for the purposes of illustration and description and is not intended to be exhaustive or to limit the disclosure to the precise forms disclosed. Many modifications and variations are possible in light of the above. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. An eye protection apparatus set on a monitor, comprising:
a distance sensor detecting a distance between a user and the monitor and sending out a distance signal;
a mode selecting unit selecting one of alarm modes;
a power supply; and
a processor connecting with the distance sensor, the mode selecting unit, the power supply, and the monitor, wherein the processor stores a predetermined value corresponding to an allowable distance between the user and the monitor, the processor compares the distance signal with the predetermined value, the eye protection apparatus alerts the user in the selected alarm mode when the distance signal is less than the predetermined value.

2. The eye protection apparatus of claim 1, wherein the alarm modes comprises an audible alarm mode, a visual alarm mode, and a power control alarm mode, the mode selecting unit comprises three buttons, each button is operable to select a corresponding alarm mode.

3. The eye protection apparatus of claim 2, comprising an audible alarm member connected to the processor.

4. The eye protection apparatus of claim 3, wherein the audible alarm member comprises a pulse generator, a resistor, a transistor, and a buzzer, a first terminal of the pulse generator is connected to the processor, a second terminal of the pulse generator is connected to a base of the transistor via the resistor, a collector of the transistor is connected to a direct current power via the buzzer, an emitter of the transistor is grounded, in the audible alarm mode, the buzzer sounds when the distance between the user and the monitor is less than the allowable distance.

5. The eye protection apparatus of claim 2, wherein in the power control alarm mode, the power supply stops powering the monitor when the distance between the user and the monitor is less than the allowable distance.

6. The eye protection apparatus of claim 2, wherein in the visual alarm mode, the monitor shows a notice when the distance between the user and the monitor is less than the allowable distance.

7. The eye protection apparatus of claim 1, further comprising a switch, wherein a first terminal of the switch is connected to the power supply, a second terminal of the switch is connected to the monitor, a third terminal of the switch is connected to the processor, the power supply supplies power to the monitor via the switch, the power supply connects or disconnects to or from the monitor via manual control of the switch.

8. The eye protection apparatus of claim 1, further comprising a switch, wherein a first terminal of the switch is connected to the power supply, a second terminal of the switch is connected to the processor, the distance sensor, and the audible alarm member, the power supply supplies power to the processor, the distance sensor, and the audible alarm member via the switch, the power supply connects or disconnects to or from the processor, the distance sensor, and the audible alarm member via control of the switch.

9. The eye protection apparatus of claim 1, wherein the distance sensor is an infrared-ray distance sensor.

10. An eye protection method, comprising:
detecting a distance between a user and a monitor and sending out a distance signal;
selecting one of alarm modes;
comparing the distance signal with a predetermined value corresponding to an allowable distance between the user and the monitor;
alerting the user in the selected alarm mode when the distance signal is less than the predetermined value.

11. The eye protection method of claim 10, wherein the alarm modes comprises an audible alarm mode, a visual alarm mode, and a power control alarm mode.

12. The eye protection method of claim 11, wherein in the audible alarm mode, a buzzer sounds when the distance between the user and the monitor is less than the allowable distance.

13. The eye protection method of claim 11, wherein in the power control alarm mode, the power supply stops powering the monitor when the distance between the user and the monitor is less than the allowable distance.

14. The eye protection method of claim 11, wherein in the visual alarm mode, the monitor shows a notice when the distance between the user and the monitor is less than the allowable distance.
